(19) United States
(12) Patent Application Publication
(10) Pub. No.: US 2016/0371095 A1
(43) Pub. Date: Dec. 22, 2016

(54) Implementation and Deletion Methods and Apparatuses for Multiple Operating Systems on Smart Device

(71) Applicant: HUAWEI DEVICE CO., LTD., Shenzhen, Guangdong (CN)

(72) Inventors: Zhigang Zhou, Shenzhen (CN); Yuandan Ke, Shenzhen (CN)

(21) Appl. No.: 14/902,468

(22) PCT Filed: Mar. 10, 2014
(86) PCT No.: PCT/CN2014/073098

§ 371 Date: Dec. 31, 2015

(30) Foreign Application Priority Data
Oct. 30, 2013 (CN) 201310528929.7

(51) Int. Cl. G06F 9/44; G06F 9/445

(52) U.S. Cl. CPC G06F 9/4406; G06F 8/61

(57) ABSTRACT

Implementation and deletion methods and apparatuses for multiple operating systems on a smart device are presented. The method includes receiving an operating instruction for installing a new operating system, where the operating instruction carries identification information of a new operating system to be installed; storing special identification information in a storage device according to the identification information of the new operating system, where the special identification information is used to instruct to enter, when a smart device is restarted, a special mode to install the new operating system; restarting the smart device, entering the special mode according to the special identification information, and allocating, according to capacity of the storage device, system space to the new operating system to be installed; updating a system partition table according to the allocated system space; and installing the new operating system in the allocated system space according to the updated system partition table.

This application is a National Stage of International Application No. PCT/CN2014/073098, filed on Mar. 10, 2014, which claims priority to Chinese Patent Application No. 201310528929.7, filed on Oct. 30, 2013, all of which are hereby incorporated by reference in their entireties.

### TECHNICAL FIELD

The present invention relates to the field of mobile terminals, and in particular, to implementation and deletion methods and apparatuses for multiple operating systems on a smart device.

### BACKGROUND

Currently, usually only one operating system, for example, an Android operating system or a Windows Phone operating system, is installed on a smart device, for example, a smartphone or an iPad. However, as smart device applications develop, two or more operating systems need to be installed on a terminal for the following reasons.

1. A security requirement: One system is a commonly used system on which applications downloaded from different markets are installed, and another system is a secure system on which only a trusted application is installed.

2. A modding requirement: One system is a factory default system, and another system is firmware manufactured by a third party and may be referred to as a custom ROM.

3. A customization requirement of a user: as two systems, where one is Android and another is WP, have respective advantages and disadvantages, they meet personal requirements of the user.

In the prior art, there is still no technology available to install two or more operating systems on a smart device. However, in a personal computer (PC), partitioning needs to be performed in advance to implement installation of multiple operating systems, a workload of implementing multiple operating systems is heavy, and operations are complex.

### SUMMARY

Embodiments provide implementation and deletion methods and apparatuses for multiple operating systems on a smart device, which can implement that a smart device adds and deletes a partition according to capacity of an embedded multimedia card (EMMC), and further implement automatic installation and deletion of multiple operating systems, so that participation of a user is not required, thereby reducing a workload.

According to a first aspect, embodiments provide an implementation method for multiple operating systems on a smart device. The method includes: receiving an operating instruction for installing a new operating system, where the operating instruction carries identification information of a new operating system to be installed and storing special identification information in a storage device according to the identification information of the new operating system, where the special identification information is used to instruct to enter, when a smart device is restarted, a special mode to install the new operating system. The method also includes restarting the smart device, entering the special mode according to the special identification information, and allocating, according to capacity of the storage device, system space to the new operating system to be installed, and updating a system partition table according to the allocated system space. The method also includes installing the new operating system in the allocated system space according to the updated system partition table.

According to the first aspect, in a first possible implementation manner, before the receiving an operating instruction for installing a new operating system, the method further includes storing an image file of the new operating system at a preset location in the storage device.

According to the first aspect or the first possible implementation manner of the first aspect, in a second possible implementation manner, before the allocating, according to capacity of the storage device, system space to the new operating system to be installed, the method further includes determining that completeness of a file system of an installed operating system on the smart device is complete.

According to the second possible implementation manner of the first aspect, in a third possible implementation manner, the determining that completeness of a file system of an installed original operating system on the smart device is complete specifically includes checking completeness of an ext4 file system of the installed operating system by using a disk check tool, and if a bad sector is detected, repairing the bad sector.

According to the first aspect or the first, second, or third possible implementation manner of the first aspect, in a fourth possible implementation manner, the allocating, according to capacity of the storage device, system space to the new operating system to be installed includes: determining a size of system space to be allocated to the new operating system; and compressing system space of the installed operating system according to the size of system space, to obtain remaining system space after the compression.

According to the first possible implementation manner of the first aspect, in a fifth possible implementation manner, the installing the new operating system in the allocated system space according to the updated system partition table includes: acquiring, from the system partition table, the system space allocated to the new operating system to be installed; and installing the image file of the new operating system in the system space allocated to the new operating system to be installed.

According to the fourth possible implementation manner of the first aspect, in a sixth possible implementation manner, after the installing the new operating system in the allocated system space, the method further includes: if a file system of the installed new operating system is less than the remaining system space after the compression, expanding capacity of user space of the new operating system.

According to a second aspect, an embodiment of the present invention provides a deletion method for multiple operating systems on a smart device, The method includes receiving an operating instruction for deleting an operating system, where the operating instruction carries identification information of an operating system to be deleted, and storing special identification information in a storage device according to the identification information of the operating system, where the special identification information is used to instruct to enter, when a smart device is restarted, a special mode to delete the operating system to be deleted. The method also includes restarting the smart device, entering the special mode according to the special identification information, acquiring, according to a system partition table, system space of the operating system to be deleted, and deleting all content in the system space, and deleting a partition corresponding to the system space in the system partition table, and expanding capacity of user space of an installed operating system on the smart device.

According to the second aspect, in a first possible implementation manner, after the deleting a partition corresponding to the system space in the system partition table, and before the expanding capacity of user space of an installed operating system on the smart device, the method further includes: determining that completeness of a file system of the installed operating system on the smart device is complete.

According to the first possible implementation manner of the second aspect, in a second possible implementation manner, the determining that completeness of a file system of the installed operating system on the smart device is complete includes: checking completeness of an ext4 file system of the installed operating system by using a disk check tool, and if a bad sector is detected, repairing the bad sector.

According to the second aspect or the first or second possible implementation manner of the second aspect, in a third possible implementation manner, the expanding capacity of user space of an installed operating system on the smart device includes: expanding the capacity of the user space of the installed operating system on the smart device according to a size of system space of the deleted operating system; or expanding the capacity of the user space of the installed operating system on the smart device according to capacity of the storage device of the smart device.

According to a third aspect, the present invention provides an implementation apparatus for multiple operating systems on a smart device. The apparatus includes a receiving unit, configured to receive an operating instruction for installing a new operating system, where the operating instruction carries identification information of a new operating system to be installed, and an identification unit, configured to store special identification information in a storage device according to the identification information of the new operating system acquired by the receiving unit, where the special identification information is used to instruct to enter, when a smart device is restarted, a special mode to install the new operating system. The apparatus also includes a configuration unit, configured to restart the smart device, enter the special mode according to the special identification information acquired from the identification unit, and allocate, according to capacity of the storage device, system space to the new operating system to be installed, and an update unit, configured to update a system partition table according to the system space allocated by the configuration unit. The apparatus also includes an implementation unit, configured to install the new operating system in the allocated system space according to the system partition table updated by the update unit.

According to the third aspect, in a first possible implementation manner, the apparatus further includes a storage unit, configured to store an image file of the new operating system at a preset location in the storage device.

According to the third aspect or the first possible implementation manner of the third aspect, in a second possible implementation manner, the apparatus further includes a determining unit, configured to determine that completeness of a file system of an installed operating system on the smart device is complete.

According to the second possible implementation manner of the third aspect, in a third possible implementation manner, the determining unit is specifically configured to: check completeness of an ext4 file system of the installed operating system by using a disk check tool, and if a bad sector is detected, repair the bad sector.

According to the third aspect or the first, second, or third possible implementation manner of the third aspect, in a fourth possible implementation manner, the configuration unit is specifically configured to: determine a size of system space to be allocated to the new operating system; and compress system space of the installed operating system according to the size of system space, to obtain remaining system space after the compression.

According to the first possible implementation manner of the third aspect, in a fifth possible implementation manner, the implementation unit is specifically configured to: acquire, from the system partition table, the system space allocated to the new operating system to be installed; and install the image file of the new operating system in the system space allocated to the new operating system to be installed.

According to the fourth possible implementation manner of the third aspect, in a sixth possible implementation manner, the apparatus further includes: a capacity expansion unit, configured to: if a file system of the installed new operating system is less than the remaining system space after the compression, expand capacity of user space of the new operating system.

According to a fourth aspect, an embodiment of the present invention provides a deletion apparatus for multiple operating systems on a smart device. The apparatus includes a receiving unit, configured to receive an operating instruction for deleting an operating system, where the operating instruction carries identification information of an operating system to be deleted, and an identification unit, configured to store special identification information in a storage device according to the identification information of the operating system acquired by the receiving unit, where the special identification information is used to instruct to enter, when a smart device is restarted, a special mode to delete the operating system to be deleted. The apparatus also includes a deletion unit, configured to restart the smart device, enter the special mode according to the special identification information acquired from the identification unit, acquire, according to a system partition table, system space of the operating system to be deleted, and delete all content in the system space, an update unit, configured to delete, after the deletion unit deletes all the content in the system space, a partition corresponding to the system space in the system partition table, and a capacity expansion unit, configured to expand capacity of user space of an installed operating system on the smart device according to the system partition table updated by the update unit.

According to the fourth aspect, in a first possible implementation manner, the apparatus further includes a determining unit, configured to determine that completeness of a file system of the installed operating system on the smart device is complete.

According to the first possible implementation manner of the fourth aspect, in a second possible implementation manner, the determining unit is specifically configured to check completeness of an ext4 file system of the installed operating system by using a disk check tool, and if a bad sector is detected, repair the bad sector.

According to the fourth aspect or the first or second possible implementation manner of the fourth aspect, in a third possible implementation manner, the capacity expansion unit is specifically configured to expand the capacity of the user space of the installed operating system on the smart device according to a size of system space of the deleted operating system, or expand the capacity of the user space of the installed operating system on the smart device according to capacity of the storage device of the smart device.

According to the implementation and deletion methods and apparatuses for multiple operating systems on a smart device provided in the embodiments of the present invention, when receiving an operating instruction for installing a new operating system, a smart device automatically adjusts, according to capacity of an EMMC storage device, a partition of an installed operating system and a partition of a new operating system to be installed, and installs, in the partition of the new operating system, an image file, stored in the storage device, of the new operating system, so that installation of multiple operating systems is implemented, and a user does not need to predefine a partition, so that it is ensured that the user can completely use all space of the smart device. When receiving an operating instruction for deleting an operating system, a smart device may also delete all content of the operating system, and automatically expand capacity of use space of an existing operating system on the smart device according to capacity of an EMMC device or a size of system space released by the operating system to be deleted, so that deletion of an operating system is implemented, and user space released by a deleted operating system can be automatically added for capacity expansion of an existing operating system, so that it is ensured that a user can completely use all space of the smart device. Therefore, in the embodiments, addition and deletion of a partition by a smart device according to capacity of an EMMC are implemented, and further, installation and deletion of multiple operating systems are implemented, so that participation of a user is not required, thereby reducing a workload.

### BRIEF DESCRIPTION OF THE DRAWINGS

FIG. 1 is a flowchart of an implementation method for multiple operating systems on a smart device according to an embodiment;

FIG. 2 is a flowchart of another implementation method for multiple operating systems on a smart device according to an embodiment;

FIG. 3 is a flowchart of a deletion method for multiple operating systems on a smart device according to an embodiment;

FIG. 4 is a flowchart of another deletion method for multiple operating systems on a smart device according to an embodiment;

FIG. 5 is a schematic diagram of an implementation apparatus for multiple operating systems on a smart device according to an embodiment;

FIG. 6 is a schematic diagram of a deletion apparatus for multiple operating systems on a smart device according to an embodiment;

FIG. 7 is a schematic diagram of a smart device according to an embodiment; and

FIG. 8 is a schematic diagram of a smart device according to an embodiment.

### DETAILED DESCRIPTION OF ILLUSTRATIVE EMBODIMENTS

Technical solutions are further described in detail with reference to the accompanying drawings and embodiments.

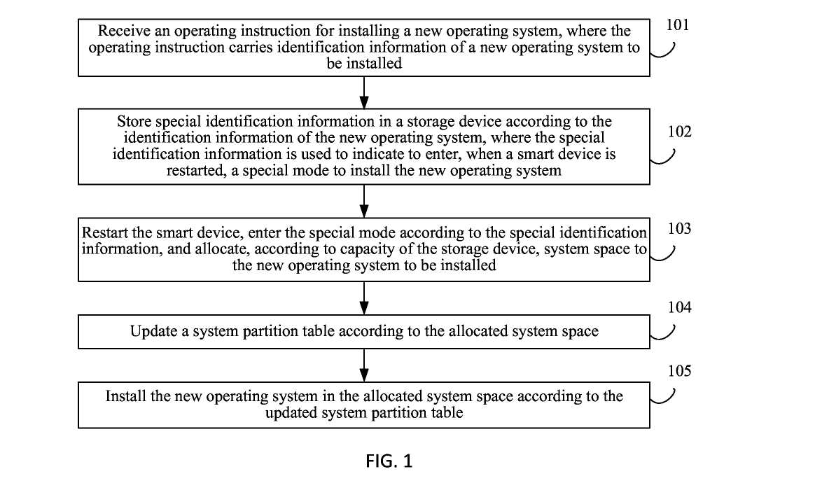

FIG. 1 is a flowchart of an implementation method for multiple operating systems on a smart device according to an embodiment. This embodiment is performed by a smart device. As shown in the figure, this embodiment includes the following steps.

Step 101. Receive an operating instruction for installing a new operating system, where the operating instruction carries identification information of a new operating system to be installed.

Generally, one operating system is installed on a smart device by default at delivery, where the operating system may provide a human-computer interaction interface, and a user may send an operating instruction to the smart device by using the human-computer interaction interface, so that the smart device performs a corresponding operation according to the received operating instruction.

Preferably, to implement multiple operating systems on the smart device, an image file of the new operating system to be installed needs to be stored in a specified directory in a storage device, for example, an EMMC, of the smart device.

Step 102. Store special identification information in a storage device according to the identification information of the new operating system, where the special identification information is used to instruct to enter, when a smart device is restarted, a special mode to install the new operating system.

After receiving the operating instruction for installing a new operating system, the smart device may first save the special identification information at a special location of an EMMC or in a random access memory (RAM), where the special identification information is used to instruct to install, after the smart device is restarted, the new operating system, and therefore, the special mode needs to be entered.

Optionally, the special mode refers to a system running on a mobile phone when an operating system is being installed or deleted, for example, a recovery mode of an Android system.

Step 103. Restart the smart device, enter the special mode according to the special identification information, and allocate, according to capacity of the storage device, system space to the new operating system to be installed.

After storing the special identification information, the smart device executes a restart process, and in a BOOT phase of the restart, if detecting the special identification information, the smart device enters a system in the special mode.

A size of system space is automatically allocated, according to capacity of the EMMC, to the new operating system to be installed, where the system space allocated to the new operating system is obtained by compressing space of an installed operating system on the smart device.

Optionally, before system space of the installed operating system is compressed, completeness of a file system of the installed operating system needs to be determined.

Step 104. Update a system partition table according to the allocated system space.

After system space is allocated to the new system, the system partition table of the smart device needs to be updated according to the allocated system space, and a partition is added, for the new operating system, to the system partition table.

Optionally, after the system partition table is updated, to ensure that the new operating system can be successfully installed, content in system space corresponding to the new partition may be erased first.

Step 105. Install the new operating system in the allocated system space according to the updated system partition table.

The image file of the new operating system is acquired from a specified directory, in which the image file of the new operating system is stored, of the EMMC, and then the new operating system can be installed in the system space corresponding to the system partition.

Preferably, if a file system of the installed new operating system is less than remaining system space that is obtained after the installed operating system on the smart device is compressed previously, capacity of user space of the new operating system may be expanded, so as to ensure that a user can use all space of the EMMC of the smart device.

In this embodiment, when receiving an operating instruction for installing a new operating system, a smart device automatically adjusts, according to capacity of an EMMC storage device, a partition of an installed operating system and a partition of a new operating system to be installed, and installs, in the partition of the new operating system, an image file, stored in the storage device, of the new operating system. Therefore, in this embodiment, automatic installation of multiple operating systems is implemented, and a user does not need to predefine a partition, so that a workload is reduced, and it can be further ensured that the user can completely use all space of a smart device.

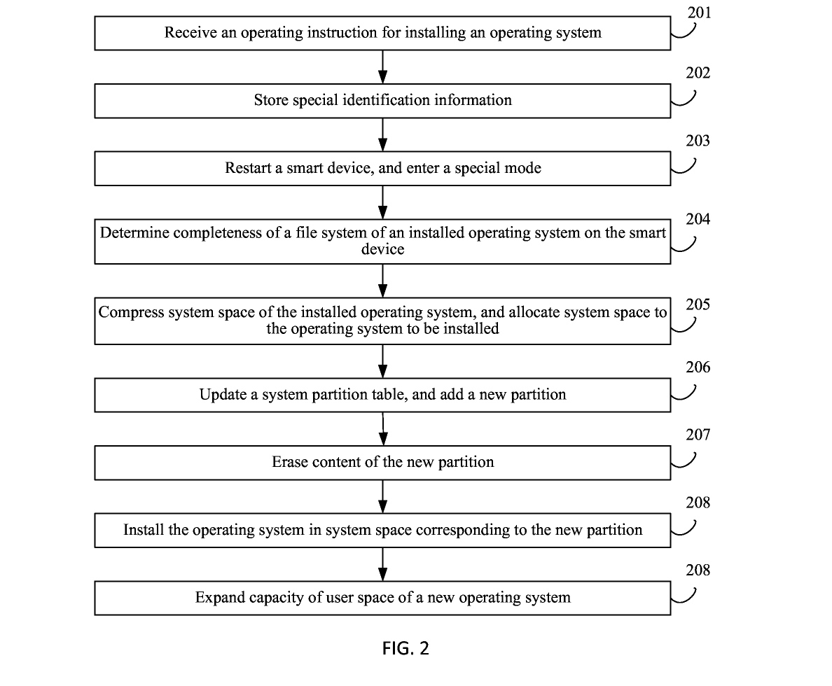

Correspondingly, an embodiment further provides a specific implementation manner of an implementation of multiple operating systems on a smart device. FIG. 2 is a flowchart of another implementation method for multiple operating systems on a smart device according to an embodiment. This embodiment is performed by a smart device. As shown in the figure, this embodiment includes the following steps.

Step 201. Receive an operating instruction for installing an operating system.

When an operating system installed by default at delivery runs on a smart device, the smart device may receive an operating instruction for installing an operating system that is sent by a user, where the operating instruction carries identification information of the operating system to be installed.

Preferably, to implement installation of a new operating system, an image file of the new operating system to be installed needs to be stored at a preset location, for example, in a specified directory of an EMMC of the smart device. For example, the image file of the new operating system may be stored in a root directory of the EMMC.

Step 202. Store special identification information.

After receiving the operating instruction for installing a new operating system, the smart device may first save the special identification information at a special location of an EMMC or in a RAM, where the special identification information is used to instruct to install, after the smart device is restarted, the new operating system, and therefore, the special mode needs to be entered.

Step 203. Restart a smart device, and enter a special mode.

The smart device executes a restart process, and in a BOOT phase of the restart, if detecting the special identification information, the smart device enters a system in the special mode.

Step 204. Determine completeness of a file system of an installed operating system on the smart device.

In the special mode, to install a new operating system, a new partition needs to be created first for the operating system, that is, system space is allocated to the operating system.

The smart device can ensure that a user can use all space of the EMMC at any time; therefore, to allocate system space to the new operating system, space of the installed operating system needs to be compressed first, and to ensure a successful compression, completeness of a file system of the operating system to be compressed needs to be determined first.

Specifically, a disk check tool, for example, an e2fsck program, may be used to check completeness of an ext4 file system, and when damage to the file system is detected, the file system is repaired, and therefore, the completeness of the file system of the installed operating system can be determined.

Step 205. Compress system space of the installed operating system, and allocate system space to the operating system to be installed.

After the completeness of the file system of the installed operating system is determined, the installed operating system may be compressed. Subsequently, system space is flexibly allocated, according to capacity of the EMMC or a size of the operating system to be installed, to the operating system to be installed.

Specifically, a file system size adjustment tool, for example, a resize2fs program, may be used to perform file compression on an ext4 system.

Step 206. Update a system partition table, and add a new partition.

After the compression succeeds, the system partition table may be adjusted, that is, a partition is added for the new operating system to be installed.

Step 207. Erase content of the new partition.

To ensure that the new operating system can be successfully installed, content in system space corresponding to the new partition may be erased first.

Step 208. Install the operating system in system space corresponding to the new partition.

The image file of the new operating system is acquired from a specified directory, in which the image file of the new operating system is stored, of the EMMC, and then the new operating system can be installed in the system space corresponding to the system partition.

Step 209. Expand capacity of user space of a new operating system.

Preferably, if a file system of the installed new operating system is less than remaining system space that is obtained after the installed operating system on the smart device is compressed previously, capacity of system space of the new operating system may be expanded, so as to ensure that a user can use all space of the EMMC of the smart device.

Therefore, in this embodiment, automatic installation of multiple operating systems is implemented, and a user does not need to predefine a partition, so that a workload is reduced, and it can be further ensured that the user can completely use all space of a smart device.

Technical solutions for implementing multiple operating systems on a smart device are described in the foregoing two embodiments, and a solution for deleting an operating system on a smart device is described below by using an embodiment.

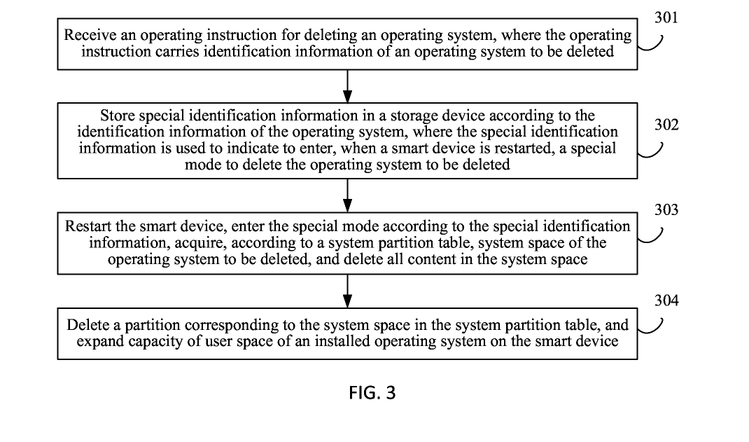

FIG. 3 is a flowchart of a deletion method for multiple operating systems on a smart device according to an embodiment. This embodiment is performed by a smart device. As shown in the figure, this embodiment includes the following execution steps.

Step 301. Receive an operating instruction for deleting an operating system, where the operating instruction carries identification information of an operating system to be deleted.

Generally, one operating system is installed on a smart device by default at delivery, where the operating system may provide a human-computer interaction interface, and a user may send an operating instruction to the smart device by using the human-computer interaction interface, so that the smart device performs a corresponding operation according to the received operating instruction.

Preferably, when a factory operating system runs on the smart device, the user may send an instruction for deleting an operating system to the smart device, and when receiving the instruction for deleting an operating system, the smart device may automatically selects an operating system to be deleted.

Step 302. Store special identification information in a storage device according to the identification information of the operating system, where the special identification information is used to instruct to enter, when a smart device is restarted, a special mode to delete the operating system to be deleted.

After receiving the operating instruction for deleting an operating system, the smart device may first save the special identification information at a special location of an EMMC or in a RAM, where the special identification information is used to instruct to delete, after the smart device is restarted, the operating system to be deleted, and therefore, the special mode needs to be entered.

Optionally, the special mode refers to a system running on a mobile phone when an operating system is being installed or deleted, for example, a recovery mode of an Android system.

Step 303. Restart the smart device, enter the special mode according to the special identification information, acquire, according to a system partition table, system space of the operating system to be deleted, and delete all content in the system space.

After storing the special identification information, the smart device executes a restart process, and in a BOOT phase of the restart, if detecting the special identification information, the smart device enters a system in the special mode.

The system partition table is searched, a location of the system space of the operating system to be deleted is acquired, and all content at the location is deleted.

Step 304. Delete a partition corresponding to the system space in the system partition table, and expand capacity of user space of an installed operating system on the smart device.

The partition to be deleted is selected in the system partition table, and in order not to waste all storage space of the EMMC, the smart device may expand capacity of the installed operating system on the smart device according to capacity of the EMMC or a size of the deleted system space.

In this embodiment, when receiving an operating instruction for deleting an operating system, a smart device may also delete all content of the operating system, and automatically expand capacity of system space of an existing operating system on the smart device according to capacity of an EMMC device or a size of system space released by the operating system to be deleted, so that deletion of an operating system is implemented, and user space released by a deleted operating system can be automatically added for capacity expansion of an existing operating system, so that it is ensured that a user can completely use all space of the smart device.

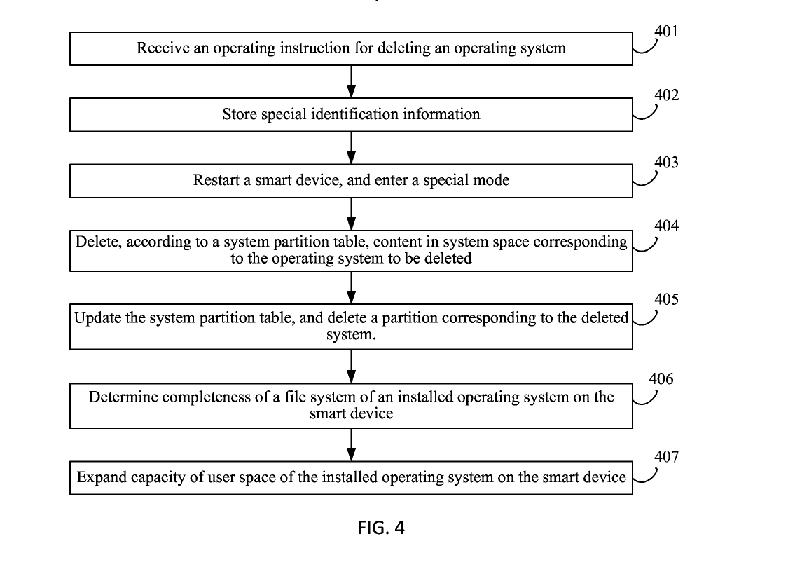

FIG. 4 is a flowchart of another deletion method for multiple operating systems on a smart device according to an embodiment. This operating system is performed by a smart device. As shown in the figure, this embodiment includes the following execution steps.

Step 401. Receive an operating instruction for deleting an operating system.

When an operating system installed by default at delivery runs on a smart device, the smart device may receive an operating instruction for deleting an operating system that is sent by a user, where the operating instruction carries identification information of an operating system to be deleted.

Step 402. Store special identification information.

After receiving the operating instruction for deleting an operating system, the smart device may first save the special identification information at a special location of an EMMC or in a RAM, where the special identification information is used to instruct to delete, after the smart device is restarted, the operating system to be deleted, and therefore, the special mode needs to be entered.

Step 403. Restart a smart device, and enter a special mode.

After storing the special identification information, the smart device executes a restart process, and in a BOOT phase of the restart, if detecting the special identification information, the smart device enters a system in the special mode.

Step 404. Delete, according to a system partition table, content in system space corresponding to the operating system to be deleted.

The system partition table is searched, a location of the system space of the operating system to be deleted is acquired, and all content at the location is deleted.

Step 405. Update the system partition table, and delete a partition corresponding to the deleted system.

After an operating system is deleted, a partition corresponding to the system in the system partition table also needs to be deleted, so as to add space of the partition for capacity expansion of an installed operating system on the smart device, and therefore, a user can use all space of the smart device, and storage space of the EMMC is not wasted.

Step 406. Determine completeness of a file system of an installed operating system on the smart device.

To expand capacity of user space of the installed operating system, completeness of the system needs to be checked first, to prevent capacity expansion from failing. Specifically, a disk check tool, for example, an e2fsck program, may be used to check completeness of an ext4 file system, and when damage to the file system is detected, the file system is repaired, and therefore, the completeness of the file system of the installed operating system can be determined.

Step 407. Expand capacity of user space of the installed operating system on the smart device.

Specifically, capacity of user space of an operating system whose capacity needs to be expanded may be automatically expanded according to capacity of the EMMC or a size of space of the deleted system. For a Linux system, a file system size adjustment tool, for example, a resize2fs program, may be used to expand capacity of an ext4 system.

Therefore, in this embodiment, deletion of an operating system is implemented, and user space released by a deleted operating system can be automatically added for capacity expansion of an existing operating system, so that it is ensured that a user can completely use all space of a smart device.

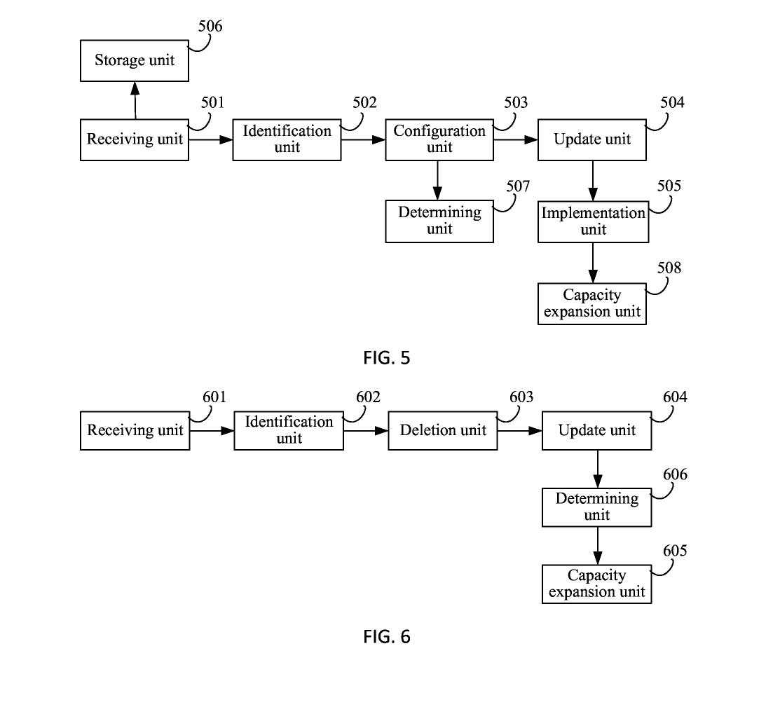

Correspondingly, an embodiment further provides an implementation apparatus for multiple operating systems on a smart device. FIG. 5 is a schematic diagram of an implementation apparatus for multiple operating systems on a smart device according to an embodiment. As shown in the figure, this embodiment includes the following functional units.

A receiving unit 501, configured to receive an operating instruction for installing a new operating system, where the operating instruction carries identification information of a new operating system to be installed.

An identification unit 502, configured to store special identification information in a storage device according to the identification information of the new operating system acquired by the receiving unit, where the special identification information is used to instruct to enter, when a smart device is restarted, a special mode to install the new operating system.

After the receiving unit 501 receives the operating instruction for installing a new operating system, the identification unit 502 may first save special identification information at a special location of an EMMC or in a RAM, where the special identification information is used to instruct to install, after a smart device is restarted, the new operating system, and therefore, the special mode needs to be entered.

Optionally, the special mode refers to a system running on a mobile phone when an operating system is being installed or deleted, for example, a recovery mode of an Android system.

A configuration unit 503, configured to restart the smart device, enter the special mode according to the special identification information acquired from the identification unit, and allocate, according to capacity of the storage device, system space to the new operating system to be installed.

The configuration unit 503 is specifically configured to: determine a size of system space to be allocated to the new operating system; and compress system space of the installed operating system according to the size of system space, to obtain remaining system space after the compression.

A size of system space is automatically allocated, according to capacity of the EMMC, to the new operating system to be installed, where the system space allocated to the new operating system is obtained by compressing space of the installed operating system on the smart device.

An update unit 504, configured to update a system partition table according to the system space allocated by the configuration unit.

After system space is allocated to the new system, the system partition table of the smart device needs to be updated according to the allocated system space, and a partition is added, for the new operating system, to the system partition table.

An implementation unit 505, configured to install the new operating system in the allocated system space according to the system partition table updated by the update unit.

The implementation unit 505 is specifically configured to: acquire, from the system partition table, the system space allocated to the new operating system to be installed; and install an image file of the new operating system in the system space allocated to the new operating system to be installed.

Optionally, to ensure that the new operating system can be successfully installed, content in system space corresponding to the new partition may be erased first before the operating system is installed.

Preferably, the apparatus provided in this embodiment further includes: a storage unit 506, configured to store the image file of the new operating system at a preset location in the storage device.

Preferably, to implement installation of a new operating system, an image file of the new operating system to be installed needs to be stored at a preset location, for example, in a specified directory of an EMMC of the smart device. For example, the image file of the new operating system may be stored in a root directory of the EMMC.

Preferably, the apparatus provided in this embodiment further includes: a determining unit 507, configured to determine that completeness of a file system of the installed operating system on the smart device is complete.

The determining unit 507 is specifically configured to: check completeness of an ext4 file system of the installed operating system by using a disk check tool, and if a bad sector is detected, repair the bad sector.

Optionally, before system space of the installed operating system is compressed, to ensure successful compression, completeness of a file system of the installed operating system needs to be determined.

Preferably, the apparatus provided in this embodiment further includes: a capacity expansion unit 508, configured to: if a file system of the installed new operating system is less than the remaining system space after the compression, expand capacity of user space of the new operating system.

If the file system of the installed new operating system is less than the remaining system space that is obtained after the installed operating system on the smart device is compressed previously, the capacity of the user space of the new operating system may be expanded, so as to ensure that a user can use all space of the EMMC of the smart device.

When receiving an operating instruction for installing a new operating system, the apparatus provided in this embodiment automatically adjusts, according to capacity of an EMMC storage device, a partition of an installed operating system and a partition of a new operating system to be installed, and installs, in the partition of the new operating system, an image file, stored in the storage device, of the new operating system. Therefore, automatic installation of multiple operating systems is implemented, and a user does not need to predefine a partition, so that a workload is reduced, and it can be further ensured that the user can completely use all space of a smart device.

Correspondingly, an embodiment further provides a deletion apparatus for multiple operating systems on a smart device. FIG. 6 is a schematic diagram of a deletion apparatus for multiple operating systems on a smart device according to an embodiment. As shown in the figure, this embodiment includes the following functional units.

A receiving unit 601, configured to receive an operating instruction for deleting an operating system, where the operating instruction carries identification information of an operating system to be deleted.

An identification unit 602, configured to store special identification information in a storage device according to the identification information of the operating system acquired by the receiving unit, where the special identification information is used to instruct to enter, when a smart device is restarted, a special mode to delete the operating system to be deleted.

After the receiving unit 601 receives the operating instruction for deleting an operating system, the identification unit 602 may first save special identification information at a special location of an EMMC or in a RAM, where the special identification information is used to instruct to delete, after a smart device is restarted, the operating system to be deleted, and therefore, the special mode needs to be entered.

Optionally, the special mode refers to a system running on a mobile phone when an operating system is being installed or deleted, for example, a recovery mode of an Android system.

A deletion unit 603, configured to restart the smart device, enter the special mode according to the special identification information acquired from the identification unit, acquire, according to a system partition table, system space of the operating system to be deleted, and delete all content in the system space.

After storing the special identification information, the apparatus executes a process of restarting the smart device, and in a BOOT phase of the restart, if detecting the special identification information, the apparatus enters a system in the special mode.

The system partition table is searched, a location of the system space of the operating system to be deleted is acquired, and all content at the location is deleted.

An update unit 604, configured to delete, after the deletion unit deletes all the content in the system space, a partition corresponding to the system space in the system partition table.

A capacity expansion unit 605, configured to expand capacity of user space of an installed operating system on the smart device according to the system partition table updated by the update unit.

The capacity expansion unit 605 is specifically configured to: expand the capacity of the user space of the installed operating system on the smart device according to a size of system space of the deleted operating system; or expand the capacity of the user space of the installed operating system on the smart device according to capacity of the storage device of the smart device.

In order not to waste all storage space of the EMMC, the capacity expansion unit 605 may expand capacity of the installed operating system on the smart device according to capacity of the EMMC or a size of deleted system space.

Preferably, the apparatus provided in this embodiment further includes: a determining unit 606, configured to determine that completeness of a file system of the installed operating system on the smart device is complete.

The determining unit 606 is specifically configured to: check completeness of an ext4 file system of the installed operating system by using a disk check tool, and if a bad sector is detected, repair the bad sector.

When receiving an operating instruction for deleting an operating system, the apparatus provided in this embodiment can also delete all content of the operating system, and automatically expand capacity of system space of an existing operating system on a smart device according to capacity of an EMMC device or a size of system space released by the operating system to be deleted, so that deletion of an operating system is implemented. In addition, the apparatus can automatically add user space released by a deleted operating system for capacity expansion of an existing operating system, thereby ensuring that a user can completely use all space of the smart device.

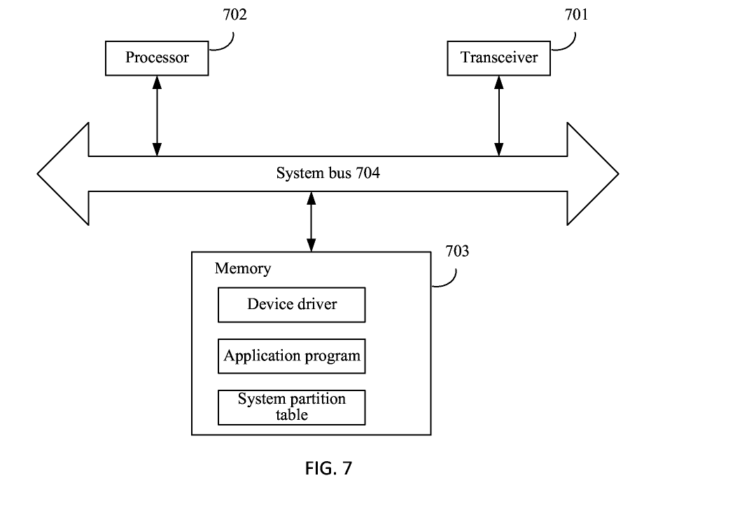

An embodiment further provides a smart device. FIG. 7 is a schematic diagram of a smart device according to an embodiment of the present invention. As shown in the figure, the smart device includes a transceiver 701, a memory 702, a processor 703, and a system bus 704, where the system bus 704 is configured to connect the transceiver 701, the processor 702, and the memory 703.

The memory 703 may be an EMMC device, a RAM, or the like, of the smart device, and the memory 703 has a system partition table, an application program, and a device driver. The application program can execute various functional modules of the foregoing method of the present invention; and the device driver may include a network driver and an interface driver.

When the smart device is started, these application programs are loaded into the memory 703 and then accessed by the processor 702, and execute the following instructions: receiving an operating instruction for installing a new operating system, where the operating instruction carries identification information of a new operating system to be installed; storing special identification information in a storage device according to the identification information of the new operating system, where the special identification information is used to instruct to enter, when a smart device is restarted, a special mode to install the new operating system; restarting the smart device, entering the special mode according to the special identification information, and allocating, according to capacity of the storage device, system space to the new operating system to be installed; updating the system partition table according to the allocated system space; and installing the new operating system in the allocated system space according to the updated system partition table.

Further, before executing the instruction of receiving an operating instruction for installing a new operating system, the processor 702 further executes an instruction: storing an image file of the new operating system at a preset location in the storage device.

Further, before executing the instruction of allocating, according to capacity of the storage device, system space to the new operating system to be installed, the processor 702 further executes an instruction: determining that completeness of a file system of an installed operating system on the smart device is complete.

Specifically, that the processor 702 executes an instruction of determining that completeness of a file system of an installed original operating system on the smart device is complete is specifically: checking completeness of an ext4 file system of the installed operating system by using a disk check tool, and if a bad sector is detected, repairing the bad sector.

Further, that the processor 702 executes an instruction of allocating, according to capacity of the storage device, system space to the new operating system to be installed is specifically: determining a size of system space to be allocated to the new operating system; and compressing system space of the installed operating system according to the size of system space, to obtain remaining system space after the compression.

Further, that the processor 702 executes an instruction of installing the new operating system in the allocated system space according to the updated system partition table is specifically: acquiring, from the system partition table, the system space allocated to the new operating system to be installed; and installing the image file of the new operating system in the system space allocated to the new operating system to be installed.

Further, after executing the instruction of installing the new operating system in the allocated system space, the processor 702 further executes an instruction: if a file system of the installed new operating system is less than the remaining system space after the compression, expanding capacity of user space of the new operating system.

Therefore, the smart device provided in this embodiment can add a partition according to capacity of an EMMC, and further implement installation of multiple operating systems, so that participation of a user is not required, thereby reducing a workload.

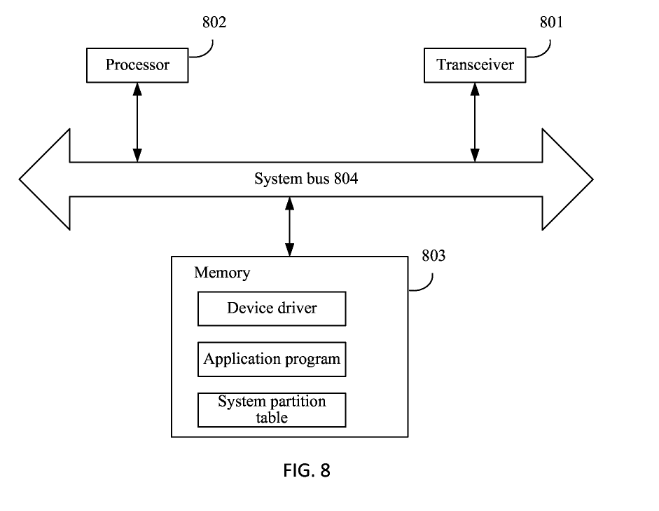

Correspondingly, an embodiment further provides a smart device. FIG. 8 is a schematic diagram of a smart device according to an embodiment. As shown in the figure, the smart device includes a transceiver 801, a memory 802, a processor 803, and a system bus 804, where the system bus 804 is configured to connect the transceiver 801, the processor 802, and the memory 803.

The memory 803 may be an EMMC device, a RAM, or the like, of the smart device, and the memory 803 has a system partition table, an application program, and a device driver. The application program can execute various functional modules of the foregoing method; and the device driver may include a network driver and an interface driver.

When the smart device is started, these application programs are loaded into the memory 803 and then accessed by the processor 802, and execute the following instructions: receiving an operating instruction for deleting an operating system, where the operating instruction carries identification information of an operating system to be deleted; storing special identification information in a storage device according to the identification information of the operating system, where the special identification information is used to instruct to enter, when a smart device is restarted, a special mode to delete the operating system to be deleted; restarting the smart device, entering the special mode according to the special identification information, acquiring, according to the system partition table, system space of the operating system to be deleted, and deleting all content in the system space; and deleting a partition corresponding to the system space in the system partition table, and expanding capacity of user space of an installed operating system on the smart device.

Further, after executing the instruction of deleting a partition corresponding to the system space in the system partition table, and before executing the instruction of expanding capacity of user space of an installed operating system on the smart device, the processor 802 further executes an instruction: determining that completeness of a file system of the installed operating system on the smart device is complete.

Specifically, that the processor 802 executes an instruction of determining that completeness of a file system of the installed operating system on the smart device is complete is specifically: checking completeness of an ext4 file system of the installed operating system by using a disk check tool, and if a bad sector is detected, repairing the bad sector.

Further, that the processor 802 executes an instruction of expanding capacity of user space of an installed operating system on the smart device is specifically: expanding the capacity of the user space of the installed operating system on the smart device according to a size of system space of the deleted operating system; or expanding the capacity of the user space of the installed operating system on the smart device according to capacity of the storage device of the smart device.

Therefore, the smart device provided in this embodiment of the present invention can automatically implement deletion of an operating system, and can automatically add user space released by a deleted operating system for capacity expansion of an existing operating system, thereby ensuring that a user can completely use all space of the smart device.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

Steps of methods or algorithms described in the embodiments disclosed in this specification may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the foregoing specific implementation manners, the objective, technical solutions, and benefits of the present invention are further described in detail. It should be understood that the foregoing descriptions are merely specific implementation manners of the present invention, but are not intended to limit the protection scope of the present invention. Any modification, equivalent replacement, or improvement made without departing from the spirit and principle of the present invention should fall within the protection scope of the present invention.

1. A method, comprising:
receiving, by a receiver, an operating instruction for installing a new operating system, wherein the operating instruction carries identification information of a new operating system to be installed;
storing special identification information in a storage device according to the identification information of the new operating system, wherein the special identification information instructs to enter, when a smart device is restarted, a special mode to install the new operating system;
restarting the smart device and entering the special mode according to the special identification information, and allocating, according to capacity of the storage device, system space to the new operating system to be installed;
updating a system partition table according to the allocated system space; and
installing the new operating system in the allocated system space according to the updated system partition table.

2. The method to claim 1, wherein before the receiving an operating instruction for installing a new operating system, the method further comprises storing an image file of the new operating system at a preset location in the storage device.

3. The method according to claim 1, wherein before allocating system space to the new operating system to be installed, the method further comprises:
determining that a file system of an installed operating system on the smart device is complete.

4. The method according to claim 3, wherein determining that a file system of an installed original operating system on the smart device is complete comprises checking completeness of an ext4 file system of the installed operating system using a disk check tool, and in response to detecting a bad sector, repairing the bad sector.

5. The method according to claim 1, wherein allocating system space to the new operating system to be installed comprises:
determining a size of system space to be allocated to the new operating system; and
compressing system space of the installed operating system according to the size of system space, to obtain remaining system space after the compression.

6. The method according to claim 2, wherein installing the new operating system in the allocated system space comprises:
acquiring, from the system partition table, the system space allocated to the new operating system to be installed; and
installing the image file of the new operating system in the system space allocated to the new operating system to be installed.

7. The method according to claim 5, wherein after the installing the new operating system in the allocated system space, the method further comprises: expanding capacity of user space of the new operating system, wherein a size of a file system of the installed new operating system is less than the remaining system space after the compression.

8. A method, comprising:
receiving, by a receiver, an operating instruction for deleting an operating system, wherein the operating instruction carries identification information of an operating system to be deleted from a smart device;
storing special identification information in a storage device according to the identification information of the operating system, wherein the special identification information instructs to enter, when a smart device is restarted, a special mode to delete the operating system to be deleted;
restarting the smart device, entering the special mode according to the special identification information, acquiring, according to a system partition table, system space of the operating system to be deleted, and deleting all content in the system space; and
deleting a partition corresponding to the system space in the system partition table, and expanding capacity of user space of an installed operating system on the smart device.

9. The method according to claim 8, wherein after deleting a partition corresponding to the system space in the system partition table, and before expanding capacity of user space of an installed operating system on the smart device, the method further comprises:
determining that a file system of the installed operating system on the smart device is complete.

10. The method according to claim 9, wherein determining that a file system of the installed operating system on the smart device is complete comprises: checking completeness of an ext4 file system of the installed operating system using a disk check tool, and in response to detecting a bad sector, repairing the bad sector.

11. The method according to claim 8, wherein expanding capacity of user space of an installed operating system on the smart device comprises:
expanding the capacity of the user space of the installed operating system on the smart device according to a size of system space of the deleted operating system.

12-22. (canceled)

23. A smart device, comprising:
one or more processors;
a non-transitory computer readable medium coupled to the one or more processors, the non-transitory computer readable medium being configured to store program codes which, when executed by the processor, cause the processor to:
receive an operating instruction for installing a new operating system, wherein the operating instruction carries identification information of a new operating system to be installed;
store special identification information in a storage device according to the identification information of the new operating system, wherein the special identification information is used to instruct to enter, when a smart device is restarted, a special mode to install the new operating system;
restart the smart device, enter the special mode according to the special identification information, and allocate, according to capacity of the storage device, system space to the new operating system to be installed;
update a system partition table according to the allocated system space; and
install the new operating system in the allocated system space according to the updated system partition table.

24. The smart device according to claim 23, wherein the program codes further cause the processor to: store an image file of the new operating system at a preset location in a storage device before the receiving the operating instruction for installing the new operating system.

25. The smart device according to claim 24, wherein installing the new operating system in the allocated system space according to the updated system partition table comprises:
acquiring, from the system partition table, the system space allocated to the new operating system to be installed; and
installing the image file of the new operating system in the system space allocated to the new operating system to be installed.

26. The smart device according to claim 23, wherein the program codes are further configured to cause the processor to, before allocating system space to the new operating system to be installed, determine that a file system of an installed operating system on the smart device is complete.

27. The smart device according to claim 26, wherein determining that the file system of the installed operating system on the smart device is complete comprises checking completeness of an ext4 file system of the installed operating system by using a disk check tool, and in response to detecting a bad sector, repairing the bad sector.

28. The smart device according to claim 23, wherein allocating system space to the new operating system to be installed comprises:
determining a size of system space to be allocated to the new operating system; and
compressing system space of the installed operating system according to the size of system space, to obtain remaining system space after the compression.

29. The smart device according to claim 28, wherein the program codes further cause the processor to, after the installing the new operating system in the allocated system space, expand capacity of user space of the new operating system;
wherein a size of a file system of the installed new operating system is less than the remaining system space after the compression.

30. The method according to claim 8, wherein expanding capacity of user space of an installed operating system on the smart device comprises:
expanding the capacity of the user space of the installed operating system on the smart device according to capacity of a storage device of the smart device.
